(19) United States
(12) Patent Application Publication
(10) Pub. No.: US 2025/0229115 A1
(43) Pub. Date: Jul. 17, 2025

(54) INTEGRAL OUTLET FIRE EXTINGUISHER ASSEMBLY

(71) Applicant: Kidde Technologies Inc., Wilson, NC (US)

(72) Inventors: Len D. Seebaluck, Wake Forest, NC (US); Aaron S. Rogers, Surf City, NC (US)

(21) Appl. No.: 18/413,665

(22) Filed: Jan. 16, 2024

(51) Int. Cl. A62C 35/02

(52) U.S. Cl. CPC A62C 35/02

(57) ABSTRACT

A fire extinguisher assembly for a vehicle includes a mounting cradle having a base comprising a base plate, the base plate partially defining an internal volume, a puncturing device disposed in the internal volume, and at least one discharge head fluidly connected to the internal volume. The fire extinguisher assembly further includes a vessel removably mounted to the mounting cradle and supported by the base plate. The vessel contains at least one fire suppression agent.

### BACKGROUND

The present invention relates to a mounting system for vehicle-borne vessels, and more particularly to a mounting system for aviation fire extinguisher vessels.

Current aviation fire extinguisher vessels include various appendages, such as attachment lugs, pressure switches, and discharge outlets, each adding weight and potential points of failure to the vessel. Accordingly, means of simplifying vessel construction to reduce cost and increase reliability are desirable.

### SUMMARY

A fire extinguisher assembly for a vehicle includes a mounting cradle having a base comprising a base plate, the base plate partially defining an internal volume, a puncturing device disposed in the internal volume, and at least one discharge head fluidly connected to the internal volume. The fire extinguisher assembly further includes a vessel removably mounted to the mounting cradle and supported by the base plate. The vessel contains at least one fire suppression agent.

A method of operating a fire extinguisher of a vehicle includes energizing a puncturing device such that a knife translates from a stowed position within a housing of the puncturing device to a deployed position in which a pointed tip of the knife extends through a weakened region of a fire extinguisher vessel, and deenergizing the puncturing device such that the knife translates back to the stowed position and a fire suppression agent within the vessel exits through a hole in the vessel and into an internal volume of a mounting cradle supporting the vessel, and subsequently, through a discharge head fluidly connected to the mounting cradle.

### BRIEF DESCRIPTION OF THE DRAWINGS

FIG. 1 is a simplified illustration of a fire extinguisher assembly.

FIG. 2 is a simplified illustration of a fire extinguisher vessel of the assembly of claim 1.

FIG. 3 is a simplified top down illustration of a cradle of the assembly of claim 1.

FIG. 4 is a simplified cross-sectional illustration of a puncturing device of the assembly of claim 1 shown in a first, stowed state.

FIG. 5 is a simplified cross-sectional illustration of the puncturing device of the assembly of claim 1 shown in a second, deployed state.

While the above-identified figures set forth one or more embodiments of the present disclosure, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features and components not specifically shown in the drawings.

### DETAILED DESCRIPTION

This disclosure presents a fire extinguisher assembly for an aircraft or other vehicle. The assembly includes a mounting cradle with integral nozzle and discharge mechanism on the aircraft side, such that vessels can be single use, and need not be formed with appendages such as mounting lugs, fill ports, or discharge outlets. Meanwhile, the aircraft-based components of the assembly are reusable and refurbishable to extend the life of the assembly.

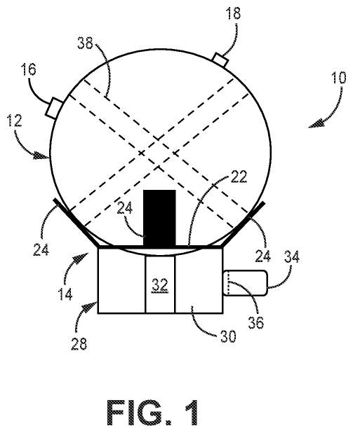

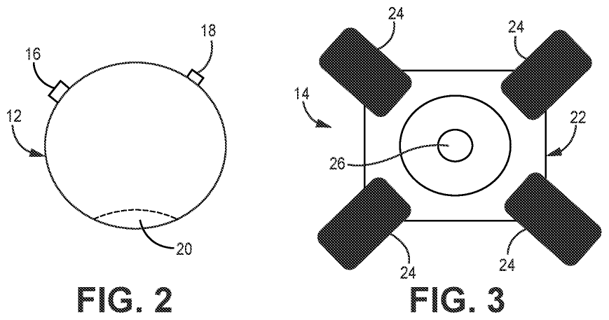

FIG. 1 is a simplified illustration of fire extinguisher assembly 10 including fire extinguisher vessel 12 and mounting cradle 14. FIG. 2 is a simplified illustration of vessel 12 shown for simplicity without the remainder of assembly 10. FIG. 3 is a simplified top plan view of mounting cradle 14 shown for simplicity without vessel 12. FIGS. 1, 2, and 3 are discussed together.

Assembly 10 includes vessel 12 supported by mounting cradle 14. Vessel 12 is removable from mounting cradle 14, which can be a fixture of the aircraft. As shown in FIGS. 1 and 2, vessel 12 can be spherical, but in an alternative embodiment, can be cylindrical and mounted in the longitudinally extending direction with a defined bottom supported by mounting cradle 14. Vessel 12 can include pressure switch 16 or other suitable means for monitoring the pressure of the fire suppression agent(s) contained within. Vessel 12 can be pressurized anywhere from 300 psi to 1500 psi in an exemplary embodiment. Vessel 12 can also include fill port 18 for introducing agent into vessel 12 after its fabrication. Vessel 12 can be fabricated by hydroforming a metallic (e.g., steel or titanium) sheet stock into hemispheres, and welding the hemispheres together to form a hermetically sealable sphere. A region of one of the hemispheres can include weakened region 20, shown in FIG. 2, at a desired location of vessel 12, for example, the gravitational bottom once placed in mounting cradle 14. Weakened region 20 can be a relatively thin region of the metallic sheet stock formed by a suitable process such as milling, mechanical scoring, laser etching, etc. to locally remove an amount or thickness of the metallic material. Weakened region 20 is designed to be mechanically punctured, as is discussed in greater detail below, to release the fire extinguishing agent from vessel 12, while being robust enough to maintain the seal of vessel 12 with its contents under expected pressures. Vessel 12 can include visible markings or other means for identifying weakened region 20 to facilitate proper mounting within mounting cradle 14.

Mounting cradle 14 can include base plate 22 with multiple support prongs 24 extending therefrom. As shown in FIG. 3, there are four support prongs 24, but more can be included in an alternative embodiment. Base plate 22 and support prongs 24 form a cradle-like structure for supporting vessel 12. Base plate 22 can include opening 26 aligned with weakened region 20 on vessel 12 allowing vessel 12 to be punctured. Mounting cradle 14 can further include base portion 28 (see FIG. 1) with internal volume 30 partially defined by base plate 22. Base portion 28 further includes puncturing device 32 housed within internal volume 30, and at least one discharge head 34 in fluid communication with internal volume 30. When fire extinguisher assembly 10 is activated, vessel 12 can be punctured, specifically at weakened region 20, with puncturing device 32, such that the fire extinguishing agent contained within vessel 12 enters internal volume 30, and is subsequently discharged through discharge head(s) 34. Each discharge head 34 can be fluidly connected to piping (not shown) for supplying the agent to one or more fire suppression spaces within the aircraft. Discharge head 34 can include debris screen 36 for filtering debris from the flow of the fire suppression agent.

To facilitate securing vessel 12 to mounting cradle 14, optional mounting straps 38 (shown with dashed lines in FIG. 1) can be placed around vessel 12. Mounting straps 38 can include various hardware, such as mounting lugs to interface with mounting cradle 14 or other mounting points on the aircraft. As such, vessel 12 need not include such mounting appendages, nor does it require attachment of discharge heads, which are incorporated into mounting cradle in the present disclosure. Vessel 12 is therefore not subjected to point loads from integral mounting lugs, nor the added weight and complexity of appendages transferred to external components in the present assembly.

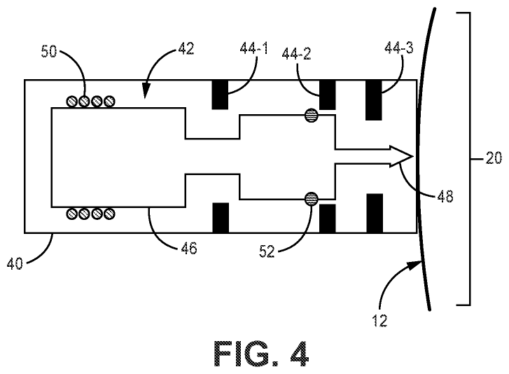

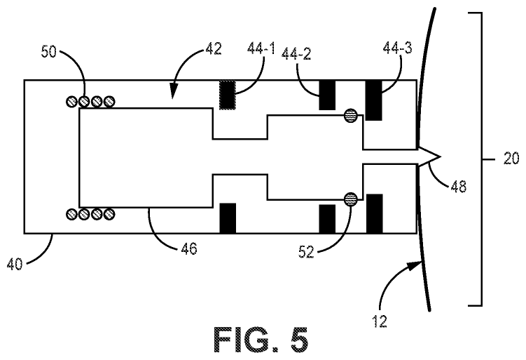

FIGS. 4 and 5 are simplified cross-sectional illustrations showing puncturing device 32 in greater detail. More specifically, FIG. 4 shows puncturing device 32 with its actuatable knife 42 in a first, stowed state, and FIG. 5 shows puncturing device 32 with actuatable knife 42 in a second, deployed state. FIGS. 4 and 5 are discussed together.

Puncturing device 32 can include housing 40 surrounding knife 42. Housing 40 can include shoulders 44 (individually labeled as shoulders 44-1, 44-2, and 44-3) to help retain knife 42 within housing 40, as is discussed in greater detail below. Knife 42 can include plunger 46 with a distal pointed tip 48. As shown in FIGS. 4 and 5, puncturing device 32 is configured as a linear solenoid actuator, having coil 50 disposed around a portion of plunger 46. In an alternative embodiment, puncturing device 32 can be mechanically actuated, for example, by a spring. In operation of puncturing device 32, knife 42 can remain in a stowed state (FIG. 4) in which knife 42 is completely contained within housing 40. If a fire suppression system associated with assembly 10 is activated (e.g. automatically by the aircraft), coil 50 can be electrically energized with current, causing plunger 46 of knife 42 to translate, within housing 40, toward vessel 12 to such extent that pointed tip 48 punctures/extends into weakened region 20 of vessel 12, as shown in FIG. 5. Knife 42 can subsequently be returned to the stowed state with the cessation of current flow through coil 50. This allows the agent within vessel to flow through the opening created by pointed tip 48, into internal volume 30 of mounting cradle 14, and through discharge head(s) 34. As such, assembly 10 does not require the use of explosive squibs to rupture vessel 12, as it is instead mechanically punctured. Squibs can contain lead azide, a hazardous compound, which is beneficially omitted from assembly 10. Further, puncturing device 32 can be used repeatedly with as many vessels 12 as are secured to mounting cradle 14 throughout the lifetime of assembly 10, whereas most traditional vessel-mounted puncturing means can only be used once.

Detent 52 can help retain knife 42 within housing in the stowed state. More specifically, detent 52 can be, for example, an o-ring or other suitable structure disposed around or otherwise connected to plunger 46 and designed to physically contact the proximate shoulder 44-2 in the stowed state. When activated to deploy, the energy exerted by coil 50 on plunger is sufficient to deform/collapse detent 52 to such degree as to allow it and plunger 46 to travel beyond shoulder 44-2. Shoulders 44-1 and 44-3 help prevent knife 42 from being ejected from housing 40 and/or stuck within vessel 12 during deployment by limiting the stroke distance of knife 42. Without such precautions, knife 42 could be ejected into or through vessel 12, become stuck or otherwise unable to restow, or become loose from housing 40 within internal volume 30 to potentially impede the flow of the agent through discharge head 34. Plunger 46 and tip 48 can be formed from a metallic material, and tip 48 can be fortified in order to puncture weakened region 20 of vessel 12. Tip 48 can be sized to create an opening in vessel 12 with a desired area, that is, to allow for the desired flow rate of agent into discharge head(s) 34.

### Discussion of Possible Embodiments

The following are non-exclusive descriptions of possible embodiments of the present invention.

A fire extinguisher assembly for a vehicle includes a mounting cradle having a base comprising a base plate, the base plate partially defining an internal volume, a puncturing device disposed in the internal volume, and at least one discharge head fluidly connected to the internal volume. The fire extinguisher assembly further includes a vessel removably mounted to the mounting cradle and supported by the base plate. The vessel contains at least one fire suppression agent.

The assembly of the preceding paragraph can optionally include, additionally and/or alternatively, any one or more of the following features, configurations and/or additional components:

The above assembly can further include a plurality of support prongs extending from the base plate, the plurality of support prongs configured to further support the vessel.

In any of the above assemblies, the plurality of support prongs can include four support prongs.

Any of the above assemblies can further include a filter screen disposed within the at least one discharge head.

In any of the above assemblies, the vessel can be formed from a metallic sheet stock.

In any of the above assemblies, the vessel can include a weakened region defined by a locally thinned region of the metallic sheet stock.

In any of the above assemblies, the vessel can be mounted to the mounting cradle such that the weakened region overlaps with a hole in the base plate.

In any of the above assemblies, the puncturing device can include a housing, an actuatable knife disposed within the housing, and an actuating means for actuating the knife.

In any of the above assemblies, the actuation means can include a solenoid.

In any of the above assemblies, the knife can include a plunger having a distal pointed tip.

In any of the above assemblies, the knife can be actuatable between a stowed position in which the knife is contained within the housing, and a deployed state in which the pointed tip extends through the weakened region of the vessel.

In any of the above assemblies, the housing can include a plurality of shoulders engagable with the plunger.

Any of the above assemblies can further include a detent disposed around the plunger.

In any of the above assemblies, the vessel can be one of a hermetically sealed sphere and a hermetically sealed cylinder.

In any of the above assemblies, the vehicle can be an aircraft.

A method of operating a fire extinguisher of a vehicle includes energizing a puncturing device such that a knife translates from a stowed position within a housing of the puncturing device to a deployed position in which a pointed tip of the knife extends through a weakened region of a fire extinguisher vessel, and deenergizing the puncturing device such that the knife translates back to the stowed position and a fire suppression agent within the vessel exits through a hole in the vessel and into an internal volume of a mounting cradle supporting the vessel, and subsequently, through a discharge head fluidly connected to the mounting cradle.

The method of the preceding paragraph can optionally include, additionally and/or alternatively, any one or more of the following features, configurations and/or additional steps:

In the above method, energizing the puncturing device can include inducing a current through a solenoid of the puncturing device.

In any of the above methods, deenergizing the puncturing device can include ceasing a flow of the current through the solenoid.

In any of the above methods, the vessel can be one of a hermetically sealed sphere and a hermetically sealed cylinder.

In any of the above methods, the vehicle can be an aircraft.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A fire extinguisher assembly for a vehicle, the assembly comprising:
a mounting cradle comprising:
a base comprising a base plate, the base plate partially defining an internal volume;
a puncturing device disposed in the internal volume; and
at least one discharge head fluidly connected to the internal volume; and
a vessel removably mounted to the mounting cradle and supported by the base plate,
wherein the vessel contains at least one fire suppression agent.

2. The assembly of claim 1 and further comprising: a plurality of support prongs extending from the base plate, the plurality of support prongs configured to further support the vessel.

3. The assembly of claim 2, wherein the plurality of support prongs comprises four support prongs.

4. The assembly of claim 2 and further comprising: a filter screen disposed within the at least one discharge head.

5. The assembly of claim 1, wherein the vessel is formed from a metallic sheet stock.

6. The assembly of claim 5, wherein the vessel comprises a weakened region defined by a locally thinned region of the metallic sheet stock.

7. The assembly of claim 6, wherein the vessel is mounted to the mounting cradle such that the weakened region overlaps with a hole in the base plate.

8. The assembly of claim 5, wherein the puncturing device comprises:
a housing;
an actuatable knife disposed within the housing; and
an actuating means for actuating the knife.

9. The assembly of claim 8, wherein the actuation means comprises a solenoid.

10. The assembly of claim 8, wherein the knife comprises: a plunger having a distal pointed tip.

11. The assembly of claim 10, wherein the knife is actuatable between a stowed position in which the knife is contained within the housing, and a deployed state in which the pointed tip extends through the weakened region of the vessel.

12. The assembly of claim 10, wherein the housing comprises a plurality of shoulders engagable with the plunger.

13. The assembly of claim 10 and further comprising: a detent disposed around the plunger.

14. The assembly of claim 1, wherein the vessel is one of a hermetically sealed sphere and a hermetically sealed cylinder.

15. The assembly of claim 1, wherein the vehicle is an aircraft.

16. A method of operating a fire extinguisher of a vehicle, the method comprising:
energizing a puncturing device such that a knife translates from a stowed position within a housing of the puncturing device to a deployed position in which a pointed tip of the knife extends through a weakened region of a fire extinguisher vessel; and
deenergizing the puncturing device such that the knife translates back to the stowed position and a fire suppression agent within the vessel exits through a hole in the vessel and into an internal volume of a mounting cradle supporting the vessel, and subsequently, through a discharge head fluidly connected to the mounting cradle.

17. The method of claim 16, wherein energizing the puncturing device comprises inducing a current through a solenoid of the puncturing device.

18. The method of claim 17, wherein deenergizing the puncturing device comprises ceasing a flow of the current through the solenoid.

19. The method of claim 16, wherein the vessel is one of a hermetically sealed sphere and a hermetically sealed cylinder.

20. The method of claim 16, wherein the vehicle is an aircraft.
